(19) United States
(12) Patent Application Publication
(10) Pub. No.: US 2007/0095504 A1
(43) Pub. Date: May 3, 2007

(54) Radiator for a work machine

(76) Inventors: John E. Tuntland, Qingdao (CN); Sean W. Johnson, Qingdao (CN); Ronald L. Dupree, Washington, IL (US); Deepak Tiwari, Evanston, IL (US); Roland E. Weisman, Buckeye, AZ (US); Jennifer Yanfang Wu, Naperville, IL (US); Eugene E. Zueck, Clayton, NC (US)

Correspondence Address: CATERPILLAR INC.;100 N.E. ADAMS STREET, PATENT DEPT., PEORIA, IL, 616296490, US

(21) Appl. No.: 11/584,912

(22) Filed: Oct. 23, 2006

Related U.S. Application Data
(60) Provisional application No. 60/729,740, filed on Oct. 24, 2005.

(51) Int. Cl. B60H 1/00

(52) U.S. Cl. 165/41; 165/47; 165/140

(57) ABSTRACT

A radiator may have a first cooler that may be connected to a lower end portion of the radiator. The first cooler may comprise a bottom compartment. The bottom compartment may have a front wall, a rear wall, first and second spaced apart side walls, a bottom wall and a lower portion. A radiator outlet port member may be connected to the lower portion. A cooling core may be positioned in the bottom compartment. A baffle may be connected to the bottom compartment and positioned above the cooling core. An opening may be disposed in the baffle at a location closer to a one of the first and second side walls than another of said first and second walls.

### RELATION TO OTHER PATENT

This application claims the benefit of prior provisional patent application Ser. No. 60/729,740 filed Oct. 24, 2005.

### TECHNICAL FIELD

The present disclosure relates generally to a radiator, more particularly, to a radiator for a work machine.

### BACKGROUND

Work machines such as, for example, a work machine having ground engaging tracks, have many working components that must be sufficiently cooled during use of the work machine. For example, a work machine may generally include an engine system, a transmission system and/or a steering and implement hydraulic system that generates heat during operation. One or more of the above systems may be cooled in order to prevent overheating. The systems and their related cooling systems can be set up according to practical practice, for example to choose one or more of the above systems and related cooling systems.

The engine may include a cooling system for cooling the engine's cooling water and oil or hydraulic fluid. The cooling water may be cooled via circulation through a radiator, which may be regulated by a thermostat, such that when the cooling water temperature is below a certain temperature, it will remain closed to prevent the cooling water from circulating through the radiator in order to bring the cooling water temperature up to operating temperature, and such that when the cooling water temperature is above a certain temperature, it will open, thereby allowing the cooling water to circulate through the radiator to reduce the cooling water temperature to a desired operating temperature. In addition, the engine's oil may be cooled via, for example, an engine oil-to-water cooler. For example, the engine's oil may be circulated through the engine, absorbing heat from its operation and then through the engine oil cooler to reduce the engine oil's temperature by absorbing at least some of its heat via the cooling water.

The transmission system and/or the steering and implement hydraulic system may also include cooling systems for cooling transmission oil and/or hydraulic fluid. The transmission oil and/or hydraulic fluid may be cooled via a cooler which is connected to the radiator. One example of such a radiator is disclosed in the U.S. Pat. No. 5,067,561 to Joshi issued Nov. 26, 1991.

The '561 patent discloses a motor radiator which has a tank, a plurality of radiator tubes (conduits), which are connected at one end thereof to the tank. A fitting is configured on the tank for directing liquid into or out of the tank to or from respectively the one end of the radiator tubes. An oil cooler is mounted in the tank between the one end of the radiator tubes and the fitting. The oil cooler has a row of tubes extending past and open to the one end of the radiator tubes. The tank has an interior side facing the oil cooler. Baffle means on opposite sides of the one end of the radiator tubes extend between the interior side of the tank and the oil cooler tubes so as to force liquid flowing between the fitting and the one end of the radiator tubes to pass transversely between the oil cooler tubes.

The above-described known art results in increased coolant velocity across the surface of the oil cooler tubes, but it makes a complex internal structure of the cooler. The coolant flowing across the oil cooler within a short distance results in a low coefficient of heat transfer and thus a lower heat transfer rate.

The disclosed radiator for a work machine is directed to overcoming one or more of the problems outlined above with respect to work machine cooling system.

### SUMMARY OF THE INVENTION

One aspect of the present disclosure includes a radiator. The radiator may have a first cooler that may be connected to a lower end portion of the radiator. The first cooler may comprise a bottom compartment. The bottom compartment may have a front wall, a rear wall, first and second spaced apart side walls, a bottom wall and a lower portion. A radiator outlet port member may be connected to the lower portion. A cooling core may be positioned in the bottom compartment. A baffle may be connected to the bottom compartment and positioned above the cooling core. An opening may be disposed in the baffle at a location closer to a one of the first and second side walls than another of said first and second walls.

Another aspect of the present disclosure includes a work machine. The work machine may have a radiator that may be connected by a first cooler at its lower end portion. The first cooler may include a bottom compartment. The bottom compartment may have a front wall, a rear wall, first and second spaced apart side walls, a bottom wall and a lower portion. A radiator outlet port member may be connected to the lower portion. A cooling core may be positioned in the bottom compartment. A baffle may be connected to the bottom compartment and positioned above the cooling core. An opening may be disposed in the baffle at a location closer to a one of the first and second side walls than another of said first and second walls.

### BRIEF DESCRIPTION OF THE DRAWINGS

FIG. 1 illustrates a functional block diagram of a cooling system for a work machine incorporating certain disclosed embodiments;

FIG. 2 illustrates another functional block diagram of cooling system for a work machine incorporating certain disclosed embodiments;

FIG. 3 is a sectional structure of the first cooler of FIG. 2 and FIG. 3 associated with the radiator;

FIG. 4 is sectional view taken along lines A-A in FIG. 4;

FIG. 5 is a side view of FIG. 4.

### DETAILED DESCRIPTION

Reference will now be made in detail to exemplary embodiments, which are illustrated in the accompanying drawings. Wherever possible, the same reference numbers will be used throughout the drawings to refer to the same or like parts.

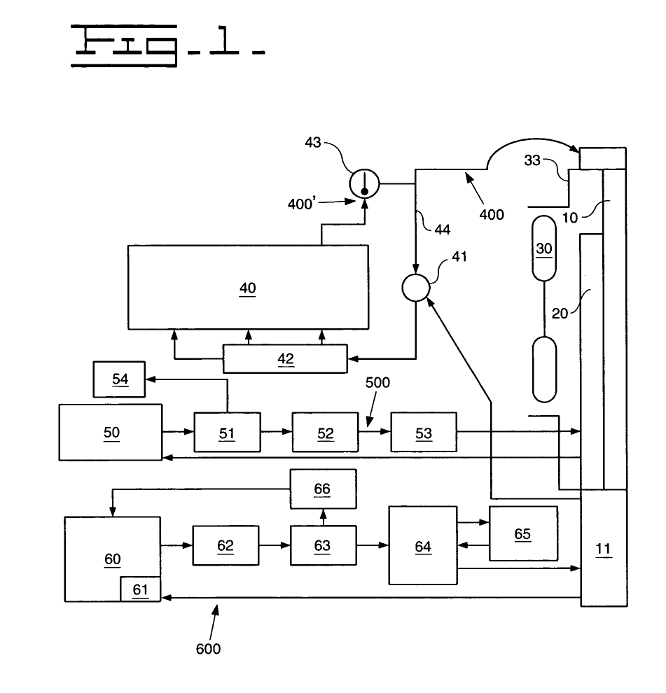

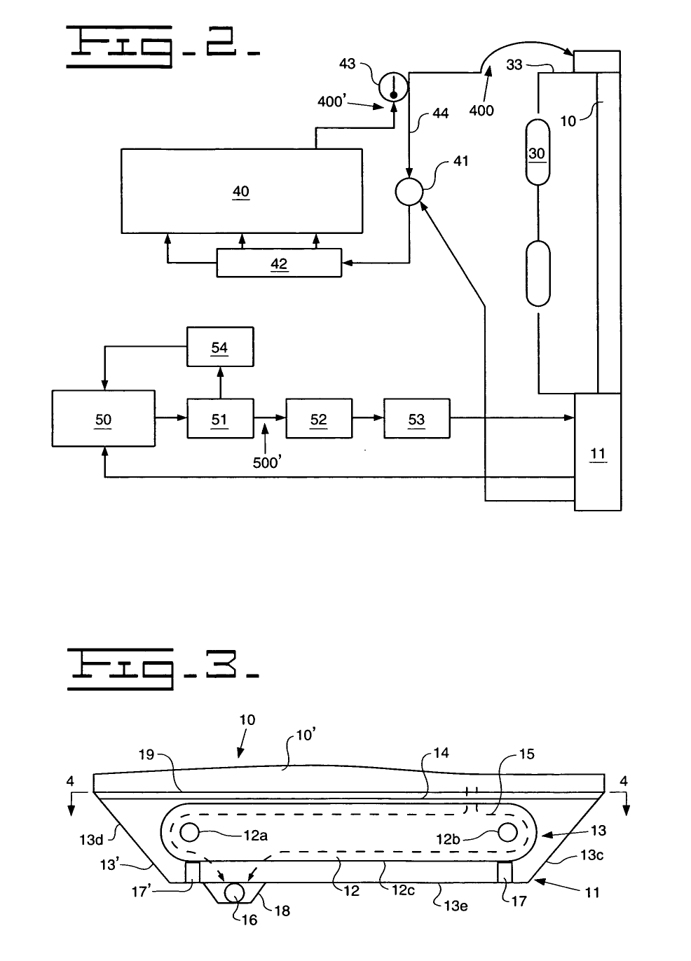

Referring to FIG. 1 and FIG. 2, they illustrate two embodiments of cooling systems of a work machine. The work machine may refer to any type of mobile machine that performs some type of operation connected to a particular industry, such as mining, construction, farming, transportation, etc. and operates between or within work environments (e.g., construction site, mine site, power plants, on-highway applications, etc.). Work machines include on-highway vehicles, commercial machines, such as trucks, cranes, earth moving vehicles, mining vehicles, backhoes, material handling equipment, farming equipment, marine vessels, aircraft, and any type of movable machine that operates in a work environment.

As shown in FIG. 1□ the work machine may include an engine cooling system 400, a transmission cooling system 500 and a steering and implement hydraulic cooling system 600. The cooling systems can be set up according to practical practice, for example to choose one or more of the cooling systems set forth above.

The engine cooling system 400 may include an engine unit 40, a circulating pump 41, a thermostat valve 43, a lube cooler 42 and a radiator 10. The engine unit 40 may be connected to the thermostat valve 43. The thermostat valve 43 may be connected to the radiator 10 and the radiator 10 may be connected to circulating pump 41. The circulating pump 41 may be connected to a lube cooler 42 and the engine unit 40 in series. A bypass conduit 44 may be connected to thermostat 43 and the circulating pump 41. The above-mentioned components may form a cooling circuit 400′, which is indicated by the arrows, of the engine cooling system.

The steering and implement hydraulic cooling system 600 may include: a first cooler 11, a hydraulic fluid tank 60, a hydraulic fluid filter 61, a pump 62, a priority valve 63, an implement hydraulic unit 66 and a steering unit. The steering unit may comprise a steering valve 64 and a steering cylinder 65. The hydraulic fluid tank 60 may be connected to the pump 62 and priority valve 63 in series by a circulating conduit. The circulating conduit may be divided into two branches from the priority valve 63. One branch may be connected to the implement hydraulic unit 66 and another branch may be connected to the steering unit that may include a steering valve 64 and a steering cylinder 65. The implement hydraulic unit 66 may be connected to the hydraulic fluid tank 60. The steering valve 64 may be connected to the first cooler 11 and the first cooler 11 may be connected to the hydraulic fluid filter 61. The hydraulic fluid filter 61 may be connected to the hydraulic fluid tank 60.

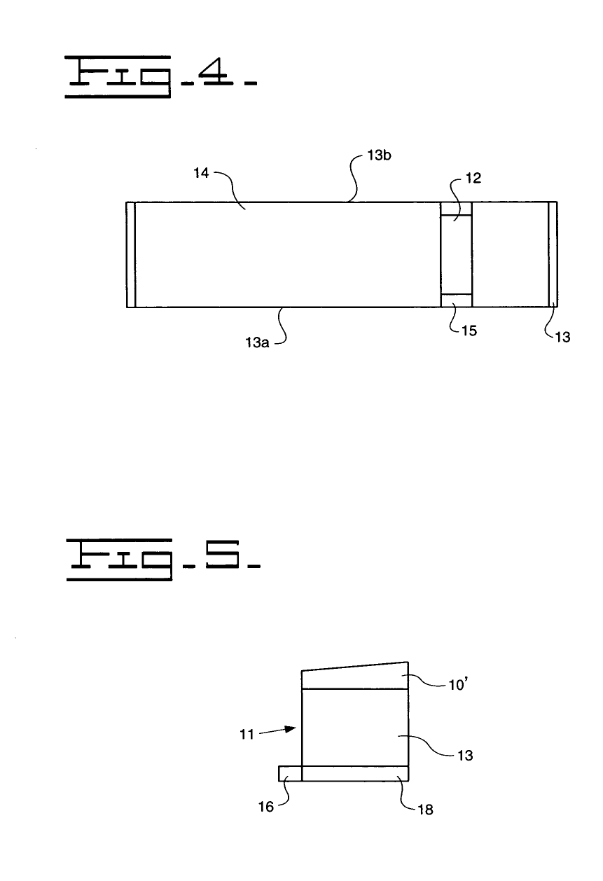

Referring to FIG. 3, FIG. 4 and FIG. 5, the first cooler 11 may be connected to the lower end portion 10′ of the radiator 10. In the lower end portion of the radiator 10′, there may be a main plate 19 to support conduits in the radiator 10. The first cooler 11 may comprise a bottom compartment 13, which may have a front wall 13a, a rear wall 13b, a first side wall 13c and a second side wall 13d spacing apart from each other, a bottom wall 13e and a lower portion 13′. A cooling core 12 may be disposed in the bottom compartment 13. The cooling core 12 may have an inlet 12a and an outlet 12b. A baffle 14, which may be connected to the bottom compartment above the cooling core 12, may extend within the bottom compartment transversely and preferably perpendicularly relative to the front wall 13a or the rear wall 13b. An opening 15 may be disposed in the baffle at a location closer to the first wall 13c than the second wall 13d or reversely. The opening 15 may extend between the front wall 13a and the rear wall 13b. A first block 17 may be positioned between a bottom 12c of the core and the bottom wall 13e and close to the first side wall 13c, and a second block 17′ may be positioned between the bottom 12c of the core and the bottom wall 13e and close to the second wall 13d. A tapered sump 18 may be connected to the bottom wall 13e of the bottom compartment 13. An outlet port member 16 may be connected to the sump 18 and extend transversely and preferably perpendicularly relative to the front wall 13a or the rear wall 13b which may be for easily being connected to circulating conduit and avoiding flat of the conduit to get low current resistance. The opening 15 may be closer to the first side wall 13c and the outlet port 16 may be closer to the second side wall 13d, which may leave a relative long path to make the water flow around the cooling core for sufficient heat exchange.

The transmission cooling system 500 may include a transmission cooler (a second cooler) 20 of an oil to air type, a transmission with oil tank 50, a transmission pump 51, a torque converter 52, an oil filter 53 and a clutch unit 54. The transmission with oil tank 50 may be connected to a transmission pump 51 by circulating conduit. Circulating conduit may be divided into two branches after the transmission pump 51. One branch conduit may be connected to the clutch unit 54 and then connected to the transmission with oil tank 50. Another branch conduit may be connected to torque converter 52 and the transmission oil filter 53 in series. The transmission oil filter 53 may be connected to the transmission cooler 20. The transmission cooler 20 may be connected to the transmission with oil tank 50. The transmission may include gears and a clutch as disclosed in the prior art.

Further referring to FIG. 1, the transmission cooler 20 may be disposed inboard of the radiator 10. A shroud 33 with an inlet may be positioned closely to the radiator. A fan 30 may be positioned in the inlet of the shroud 33.

FIG. 2 illustrates another improved embodiment of cooling system of a work machine, which may include an engine cooling system 400 and a transmission cooling system 500′.

The engine cooling system 400 in FIG. 2 may be the same as in FIG. 1. The transmission cooling system 500′ may include a first cooler 11, a transmission with oil tank 50, a transmission pump 51, a torque converter 52, an oil filter 53 and a clutch unit 54. The transmission with oil tank 50 may be connected to a transmission pump 51 by circulating conduit. Circulating conduit may be divided into two branches after the transmission pump 51. One branch conduit may be connected to the clutch unit 54 and then connected to the transmission with oil tank 50. Another branch conduit may be connected to torque converter 52 and the transmission oil filter 53 in series. Then the transmission oil filter 53 may be connected to the first cooler 11. The first cooler 11 may be connected to the transmission with oil tank 50.

Referring to FIG. 3, FIG. 4 and FIG. 5, the first cooler 11 may be connected to the lower end portion 10′ of the radiator 10. In the lower end portion of the radiator 10, there may be a main plate 19 to support the conduits in the radiator. The first cooler 11 may comprise a bottom compartment 13, which have a front wall 13a, a rear wall 13b, a first side wall 13c and a second side wall 13d spacing apart from each other, a bottom wall 13e and a lower portion 13′. A cooling core 12 may be disposed in the bottom compartment 13. The cooling core 12 may have an inlet 12a and an outlet 12b. A baffle 14, which may be connected to the bottom compartment above the cooling core 12, may extend within the bottom compartment transversely and preferably perpendicularly relative to the front wall 13a or the rear wall 13b. An opening 15 may be disposed in the baffle at a location closer to the first wall 13c than the second wall 13d or reversely. The opening 15 may extend between the front wall 13a and the rear wall 13b. A first block 17 may be positioned between a bottom 12c of the core and the bottom wall and close to the first side wall 13c, and a second block 17′ may be positioned between the bottom 12c of the core and the bottom wall 13e and close to the second wall 13d. A tapered sump 18 may be connected to the bottom wall 13e of the bottom compartment 13. An outlet port 16 member may be connected to the sump 18 horizontally, which may be for easily being connected with circulating conduit and avoiding flat of the conduit to get low current resistance. The opening 15 may be closer to the first side wall 13c and the outlet port 16 may be closer to the second side wall 13d, which may leave a relative long path to make the water flow around the cooling core for sufficient heat exchange.

### INDUSTRIAL APPLICABILITY

Referring to FIG. 1, in operation, when the cooling water temperature in the radiator reaches a certain temperature, the thermostat valve 43 may open the bypass conduit. Pump 41 may pump may pump water from engine unit 40 through the thermostat valve 43, pump 41, lube oil cooler 42 and return to the engine unit. The opening thermostat valve may prevent the cooling water from circulating through the radiator in order to bring the cooling water temperature up to operating temperature, and such that when the cooling water temperature may be above a certain temperature, the thermostat valve may close the bypass conduit 44 by controlling circuit. Pump 41 may pump water from engine unit 40 through the thermostat valve 43, the radiator 10, pump 41, lube oil cooler 42 and returns to the engine unit 40. This circulation may allow the cooling water to circulate through the radiator to reduce the cooling water temperature to a desired operating temperature.

The cooling method of the steering and implement hydraulic cooling system may include pumping the hydraulic fluid from the hydraulic fluid tank 60 to the hydraulic fluid pump 62, then to the priority valve 63. A portion of the hydraulic fluid may be passed from priority valve 63 to the steering unit and then passed into the first cooler 11 by one of the branch conduits. The other portion of the hydraulic fluid may be passed into implement hydraulic unit 66 by another branch conduit. The hydraulic fluid from the steering unit may be passed into first cooler 11 and then returned to the filter 61 and to the hydraulic fluid tank 60. The hydraulic fluid from implement unit 66 may be returned to the hydraulic fluid tank 60.

In the first cooler 11, the hydraulic fluid may be passed into the cooling core 12 through the inlet 12a from the steering valve 64. Water, which may be cooled in the radiator 10, may flow down to the baffle 14 first and pass into the bottom compartment 13 through opening 15. While water may flow downward to the tapered sump 18 and then to the outlet port 16, block 17 and block 17 may work with the opening 15 to direct water to flow around the cooling core 12, as indicating by the arrows in FIG. 3, for better heat exchange comparing with the present art. Water passing out of the outlet port 16 may enter into further circulation of the engine cooling system. After heat exchange in the bottom compartment 13, hydraulic fluid may be passed out of the cooling core 12 through the outlet 12b to the hydraulic fluid filter 61 and to the hydraulic fluid tank 60. Within this circulation, hydraulic fluid may exchange heat with the water in the bottom compartment 13 to reduce the hydraulic fluid temperature to a desired operating temperature.

The cooling method of the transmission cooling system may include pumping a portion of transmission oil to the clutch unit 54 through transmission pump 51 and return to the transmission with oil tank 50. The other portion of transmission oil may be pumped to the torque converter 53 through the transmission pump 51, the transmission oil filter 53, the second cooler 20 and return to the transmission with oil tank 50. During this circulation, transmission oil exchange heat with air to reduce the transmission oil temperature to a desired operating temperature.

During the operation of the work machine, the fan 30 may blow air through both the radiator 10 and the transmission cooler 20 for heat exchange, which may reduce the temperature of the engine system, the transmission system and the steering and implement hydraulic system.

Referring to FIG. 2, the operation of the engine cooling system in FIG. 2 may be the same as in FIG. 1.

The cooling method of the transmission cooling system in FIG. 2 may include pumping a portion of transmission oil to the clutch unit 54 through transmission pump 51 and return to the transmission with oil tank 50. The other portion of transmission oil may be pumped to the torque converter 53 through the transmission pump 51, the transmission oil filter 53, the first cooler 11 and return to the transmission with oil tank 50.

In the first cooler 11, the transmission oil may be passed into the inlet 12a of the core 12 from the torque converter 53. Water, which may be cooled in the radiator 10, may flow down to the baffle 14 first and pass into the bottom compartment 13 through opening 15. While water may flow downward to the tapered sump 18 and then to the outlet port 16, block 17 and block 17′ may work with the opening 15 to direct water to flow around the cooling core 12, as indicating by the arrows in FIG. 3, for better heat exchange comparing with the present art. Water passing out of the outlet port 16 may enter into further circulation of the engine cooling system. After exchanging heat in the bottom compartment 13, the transmission oil may be passed out of the cooling core through the outlet 12b and return to the transmission with oil tank 50. Within this circulation, the transmission oil may exchange heat with the water in the bottom compartment 13 to reduce the transmission oil temperature to a desired operating temperature.

During the operation of the work machine, the fan 30 may blow air through the radiator for heat exchange, which may reduce the temperature of the engine system, the transmission system □

It will be apparent to those skilled in the art that various modifications and variations can be made to the disclosed the radiator and work machine. Other embodiments will be apparent to those skilled in the art from consideration of the specification and practice of the disclosed sealing box and pressured cab. It is intended that the specification and examples be considered as exemplary only, with a true scope being indicated by the following claims and their equivalents.

What is claimed is:

1. A radiator having a lower end portion and a first cooler connected to the lower end portion, said first cooler comprising:
a bottom compartment, said bottom compartment having a front wall, a rear wall, first and second spaced apart side walls, a bottom wall and a lower portion;
a radiator outlet port member being connected to the lower portion;
a cooling core being positioned in the bottom compartment;
a baffle being connected to the bottom compartment and being positioned above the cooling core;
an opening disposed in the baffle at a location closer to a one of the first and second side walls than another of said first and second walls.

2. The radiator as claimed in claim 1, said opening extending between the front wall and the rear wall.

3. The radiator as claimed in claim 1, including at least a first block, the first block being positioned between a bottom of the core and the bottom wall, and close to the one of said the side walls.

4. The radiator as claimed in claim 3, including a second block, the second block being positioned between the bottom of the core and the bottom wall, and close to said another of said side walls.

5. The radiator as claimed in claim 1, said outlet port member being connected to the lower portion and extending transversely from the lower portion relative to one of the first and second side walls.

6. The radiator as claimed in claim 1, further comprising a sump, the sump being connected to the bottom wall of the bottom compartment, the outlet port member being connected to the sump and extending transversely relative to one of the front wall and the rear wall.

7. The radiator as claimed in claim 6, the sump is a tapered compartment.

8. The radiator as claimed in claim 1, said baffle being connected to the bottom compartment and extending transversely relative to one of the front wall and the rear wall.

9. The radiator as claimed in claim 8, said baffle being connected to the bottom compartment and extending perpendicularly relative to one of the front wall and the rear wall.

10. The radiator as claimed in claim 1, said opening being closer to one of the side walls and said outlet port being closer to said another of said side walls.

11. A work machine having a radiator and a first cooler connected to a lower end portion of the radiator, said first cooler comprising:
a bottom compartment, said bottom compartment having a front wall, a rear wall, first and second spaced apart side walls, a bottom wall and a lower portion;
a radiator outlet port member being connected to the lower portion;
a cooling core being positioned in the bottom compartment;
a baffle being connected to the bottom compartment and being positioned above the cooling core;
an opening disposed in the baffle at a location closer to a one of the first and second side walls than another of said first and second walls.

12. The work machine as claimed in claim 11, said opening extending between the front wall and the rear wall.

13. The work machine as claimed in claim 11, including a first block, the first block being positioned between a bottom of the core and the bottom wall, and close to the one of said side walls.

14. The work machine as claimed in claim 13, including a second block, the second block being positioned between a bottom of the core and the bottom wall, and close to said another of said side walls.

15. The work machine as claimed in claim 11, said outlet port member being connected to the lower portion and extending transversely from the lower portion relative to one of the first and second side walls.

16. The work machine as claimed in claim 11, further comprising a sump, the sump being connected to the bottom wall of the bottom compartment, the outlet port member being connected to the sump and extending transversely relative to one of the front wall and the rear wall.

17. The work machine as claimed in claim 16, the sump is a tapered compartment.

18. The work machine as claimed in claim 11, said baffle being connected to the bottom compartment and extending transversely relative to one of the front wall and the rear wall.

19. The work machine as claimed in claim 18, said baffle being connected to the bottom compartment and extending perpendicularly relative to one of the front wall and the rear wall.

20. The work machine as claimed in claim 11, further including a second cooler, the second cooler being positioned inboard the radiator.

21. The work machine as claimed in claim 20, said second cooler being of fluid to air type.

22. The work machine as claimed in claim 11, said opening being closer to one of the side walls and said outlet port being closer to said another of said side walls.
